(19) United States
(12) Patent Application Publication
(10) Pub. No.: US 2009/0064082 A1
(43) Pub. Date: Mar. 5, 2009

(54) METHOD FOR CUSTOM REGISTER CIRCUIT DESIGN

(75) Inventors: Giorgos S. Tsapepas, Poughkeepsie, NY (US); Michael H. Wood, Poughkeepsie, NY (US)

Correspondence Address: CANTOR COLBURN LLP-IBM POUGHKEEPSIE, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/845,124

(22) Filed: Aug. 27, 2007

(51) Int. Cl. G06F 17/50

(52) U.S. Cl. 716/18

(57) ABSTRACT

A computer program product stored on machine readable media is disclosed. The computer program product includes machine executable instructions for implementing a method of automatically creating a custom register circuit with a Computer Aided Design (CAD) application. The method includes obtaining parameters of the custom register circuit via a graphical user interface, executing one or more custom functions using the obtained parameters, and creating a cell comprising the custom register circuit.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method of custom register circuit design in the development of microprocessors.

2. Description of Background

Existing circuit design software, such as CADENCE™ from Cadence Design Systems Inc. of San Jose, Calif. for example, may be used to create custom register circuits, typically via a manual process. A typical design cell includes three main parts: a schematic; a symbol; and a layout.

Creation of a typical circuit register typically includes a number of such manual steps that include creating a custom latch sub-cell including at least one latch and any other logic appropriate for the input to that latch, as defined by a very high speed integrated circuit hardware description language (vhdl) or circuit designer. (This can be referred to as a “bit-slice” if one latch is used, indicating that this cell will then be replicated multiple times to create the register.) Additional steps include: placing the bit-sliced custom latch cell in the schematic and vectoring it as many times as bits needed in the register; placing proper clocks in the schematic, and efficiently associating each clock to the correct amount of latch sub-cells; defining labels for the clock, scan_in, scan_out, data_in and data_out pins on the latch cell, including a direction of scan chain and order of pre-defined latch cells as they will be placed in the layout. If a user utilizes an automated layout design tool, they must define x and y locations for each latch sub-cell while noting the order in which to place the different types of latch cells they have to be placed, as many registers contain multiple types of latches, data, parity, error, and error checking, and each of these latch types generally have their own sub-cell to be created and placed in the schematic separately by the designer. Creation of a typical circuit register further includes creating a symbol view of the register cell and a layout including all connectivity definitions and instance order of all instances from the schematic.

This manual methodology is very time consuming and leaves room for human error. Furthermore, the aspect of human error adds to the design creation time in fixing tedious errors. Accordingly, there is a need in the art for a custom register design arrangement that overcomes these drawbacks.

### SUMMARY OF THE INVENTION

The shortcomings of the prior art are overcome and additional advantages are provided through the provision of a method for automated custom register circuit design.

An embodiment of the invention includes a computer program product stored on machine readable media. The computer program product includes machine executable instructions for implementing a method of automatically creating a custom register circuit with a Computer Aided Design (CAD) application. The method includes obtaining parameters of the custom register circuit via a graphical user interface, executing one or more custom functions using the obtained parameters, and creating a cell comprising the custom register circuit.

A further embodiment of the invention includes s method for automatically creating a custom register circuit with an electronic Computer Aided Design (CAD) application. The method includes obtaining parameters of the custom register circuit via a graphical user interface, executing one or more custom functions using the obtained parameters, and creating a cell comprising the custom register circuit.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which drastically reduces the time for a circuit designer to create a custom circuit register by use of a custom register design tool that eliminates the complication of symbol and schematic creation and calls upon other tools to quickly create the layout.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an infrastructure for operation of an automatic CADENCE register circuit designer.

FIG. 2 illustrates one example of a flowchart of a method for automatically creating a custom CADENCE register circuit.

FIG. 3 illustrates one example of a graphical user interface to input parameters to the automatic CADENCE register circuit designer.

The detailed description explains the preferred embodiments of the invention, together with advantages and features, by way of example with reference to the drawings.

### DETAILED DESCRIPTION OF THE INVENTION

An embodiment of the invention provides an automated means for creating a custom circuit register in an electronic Computer Aided Design (CAD) application, such as CADENCE. The automated means eliminates the complication of symbol and schematic creation, and calls upon other tools to quickly place all instances in a layout including necessary connectivity in an order the designer wishes to implement. In one embodiment, the typical register creation steps are eliminated, such that the user must only create the custom latch bit-slice. Another embodiment provides a graphical user interface (GUI) as a seamless means for the user to define all aspects of the register for its quick creation.

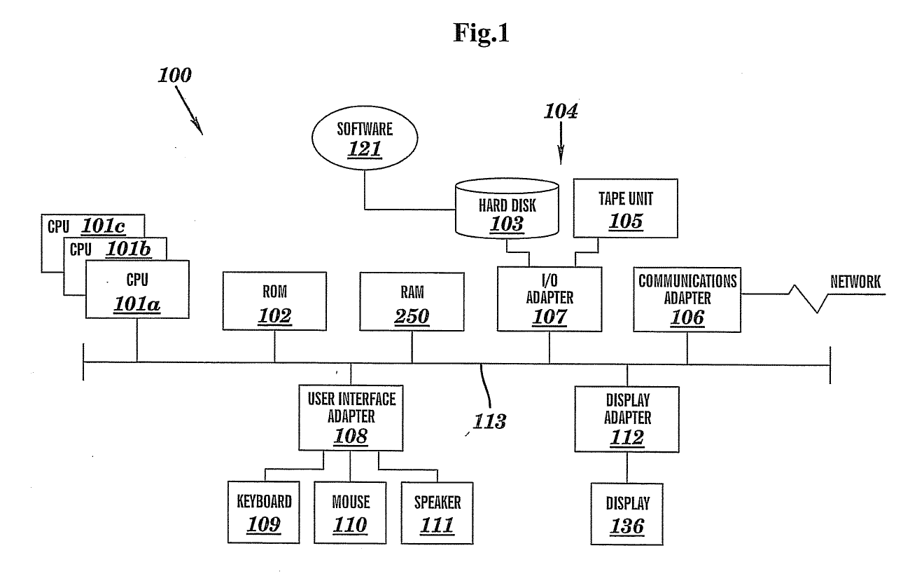

Referring to FIG. 1, an embodiment of a processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. A network adapter 106 interconnects bus 113 with an outside network 120 enabling data processing system 100 to communicate with other such systems. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 104) for designing a custom circuit register within commercially available circuit design software, such as CADENCE™, available from Cadence Design Systems Inc. of San Jose Calif. a circuit design. As referred to herein, the instructions are referred to as “design layout software” 121. The software 121 may be produced using software development tools as are known in the art. As discussed herein, the software 121 may also be referred to as a “register designer” 121 or simply as a “designer” 121. The designer 121 may include various editing tools and layout features as are known in the art.

The designer 121 permits the user to focus on a particular aspect of a circuit layout, or a layout of a similar nature that has been previously created for use within a new, or custom circuit. As used herein, these aspects are generally referred to as “registers” within a layout.

In some embodiments, the designer 121 provides users with an interface for the user to define all aspects of the register for its quick creation in response to query input information. In some embodiments, object information is determined by performing a query for a given location. For example, by initiating a query (such as by a keyboard command, a right click, use of a pulldown menu, or by other similar techniques) and by using a pointing device (such as the mouse 110) the user provides query input. Query input may be provided by selecting at least one of a given set of coordinates (such as by indicating a single point, a region of points) and at least one object. In this example, and as a result to the query, the designer 121 returns all objects associated with the single point or region of points.

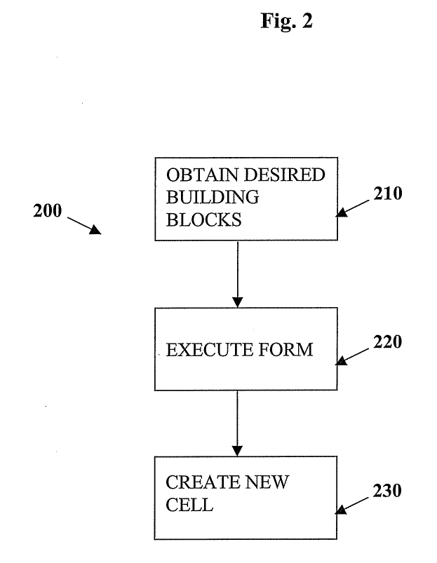

FIG. 2 depicts a flowchart 200 of an exemplary process performed by the designer 121 executing on the processor 101, to provide the create the custom circuit register, such as a custom circuit register within CADENCE™ software 121, as described above. The process begins at block 210 by obtaining desired building blocks, or parameters for the custom register, such as details associated with the schematic, the symbol, and the layout of the new cell, for example. In one embodiment, the obtaining the desired parameters of the register, at block 210, is via a form, or graphical user interface displayed upon the display 136, with the user utilizing an input device, such as the keyboard 109 and mouse 110 for example. The process continues at block 220 with the designer 121 executing one or more custom CADENCE™ functions that utilize the parameters that have been provided within the graphical user interface. Finally, the process concludes at block 230 by creating the new cell of the custom circuit register that includes at least one of the symbol, schematic, and layout of the desired custom register.

In one embodiment, the executing the building blocks at block 220 includes executing a plurality of custom CADENCE™ functions that are called by the designer 121, to automatically create a cell of a custom CADENCE™ register circuit. A description of each custom CADENCE™ function, its input parameters, and tasks follow.

A SBBregBldSymbol( ) function builds the symbol of the new cell and is passed the following variable parameters as input: symbol, which specifies a cell view in which to create the symbol; useBits, which specifies which bits to use in the register from a dsImage variable; latName, which specifies a latch name to use in the register; latLib, which specifies a latch library in which to find a latch to use in the register; placeLcb, which includes either a “true” or “false” status to define whether or not to place a local clock block (lcb); lcbLib, which specifies a library in which to find the lcb to be placed; lcbName, which specifies a name of the lcb to use if the lcb is to be placed; dsParent, which specifies a cell name and library from which to use to use dsImage; and dsImageArg, which is a user defined dsImage to use for a register pattern.

The SBBregBldSymbol( ) function then performs the following tasks to build the symbol of the new cell. It first creates useBits and latName lists, if they do not currently exist, to provide easier manipulation later. It gathers information from the dsParent parameter, or passes the dsImageArg parameter to variable dsImage. It creates a table that associates different latch types with their respective useBits, and creates one list including input pins and another list containing output pins of the latch to be used. The individual input and output bits are then checked to ensure that there are no duplicates and further, that there are no omissions due to similarity

The useBits list, latName list, input pins list, and output pins list are combined using a SBBregBld_mysort( ) function and a SBBregBldCombineContinuousBitsGT( ) function, which will be described further below, to shorten the labels. The SBBregBldSymbol( ) function then utilizes a FIPSymbolCreateSquarePin( ) to create the input and output pins in the symbol view. A schCreateSymbolShape( ) is used to create a rectangle shape in the symbol view to represent the register. The FIPSymbolCreateSquarePin( ) is then called to place Scan_in and Scan_out pins on the symbol shape.

SBBregBldSymbol( ) then proceeds to determine if clock pins of the lcb shall be placed on the symbol shape: if the lcb is placed on the symbol shape, then the lcb inputs are placed on the symbol, if an lcb is not placed, then the output pins of the lcb are placed as inputs to the register. Note that the lcb pin labels are created using a SBBregBldLCBCounter( ) function, as will be described further below. Finally, two labels are placed for a cellName parameter and instanceName parameter of the symbol view.

The SBBregBld_mysort( ) function is used to ensure that common bit names are combined. The function is passed two bit names, which include the syntax bitName<number>. The function compares the two bit numbers, and if the first is larger than the second, a “t” (indicating a true status, that the bit names are not common), is returned.

The SBBregBldLCBCounter( ) function is passed the dsImage and useBits parameters. The dsImage parameter is parsed using the “|” symbol. Each group of bits gathered from this parse is then compared to the useBits parameter. If there is a bit in the grouping that is also in the useBits parameter, an lcb is counted to be used in that region. These are compared by expanding the useBits parameter by using a RBCbldFindContiguousBits( ) function, which will be described further below.

The SBBregBldCombineContinuousBitsGT( ) function is passed one parameter, an input list, in the form of a string of bits separated by “,”. This function takes the input list and checks the value of each bit. It finds the smallest and largest bits having the same type and returns those values in the syntax <x:y> (where x is the smallest and y is the largest value), as combined inputs at the end of the function.

A SBBregBldSchematic( ) function builds the schematic of the cell, and is passed the following variable input parameters: schematic, which specifies the cell view name for the schematic; useBitsList, which specifies which bits to use in the register from the dsImage parameter; scanDir, which specifies a direction of a scan chain (left to right or right to left); placeLcb, which returns a “t” or “f” (true or false), depending on whether or not to place the lcb; lcbName, which specifies a lcb name to use, if one is desired; lcbLib, which specifies a lcb library to use, if desired; lcbDsType, which specifies an identifier for lcb position within the dsImage; libName, which specifies a library from which to find latches to use for the register; cellNameList, which specifies different latches to use for register; dsParent, which specifies a cell name and library from which to use the dsImage parameter; dsImageArg, which is a user defined dsImage to use for a pattern of the register; lcbRot, which specifies an orientation of the lcb to be placed; and alignC1, which specifies whether or not to align c1 pins between latches and lcbs.

The SBBregBldSchematic( ) function gathers information from the dsParent parameter, or passes the dsImageArg parameter to variable dsImage. Further, inside a for loop for each useBit bit type the SBBregBldSchematic( ) function performs the following: properly orders bits in the useBitsList From the scanDir parameter for correct scan order; determines the scan_in and scan_out chain for the entire register based on the scanDir and useBits parameters; determines the latch type that is currently being created; creates the clock pin labels for the lcb and latches; and creates appropriate clock pins if the lcb is not desired to be placed including wire models for proper analysis. If an lcb is desired, it is placed, including all correct labels and wire models for proper analysis. Finally, the SBBregBldSchematic( ) function creates latch labels for clock and scan pins, with appropriate labels depending on the latch used, creates an instance for the appropriate useBits and latch type currently being processed by the for loop, and places all pins on instance, clock, data, and scan, including labels previously created.

A RBCbldFindContiguousBits( ) function is passed one parameter, an input list, in the form of a string of bits in the syntax <a:e> (where a is the smallest and e is the largest value). It then returns those values, in the form of a string of bits, each bit between the smallest and largest value separated by “,”. A SBBregBldFindPCSkip( ) function changes a parameter fed to a FIPPIPPlaceByInstanceParamete function (described further below) calculates how many skip bits are needed to align C1 pins.

A SBBregBld_ClockPinLabels( ) function is passed the following parameters: dsImage, which specifies a user defined dsImage to use for the register pattern; name, which specifies the useBit latch type name; beginning, which specifies a first bit in a list of useBits; end, which specifies a last bit in the list of useBits; and step, which specifies an amount to increment. The SBBregBld_ClockPinLabels( ) function counts the number of clocks in the list from “|” found in dsImage and creates an appropriate label for each bit based on it's position in the dsImage parameter with relation to the “|” symbol.

Finally, a SBBregBldLayout( ) function uses a FIPPIPPlaceByInstanceParameter( ) to place the register components within the layout.

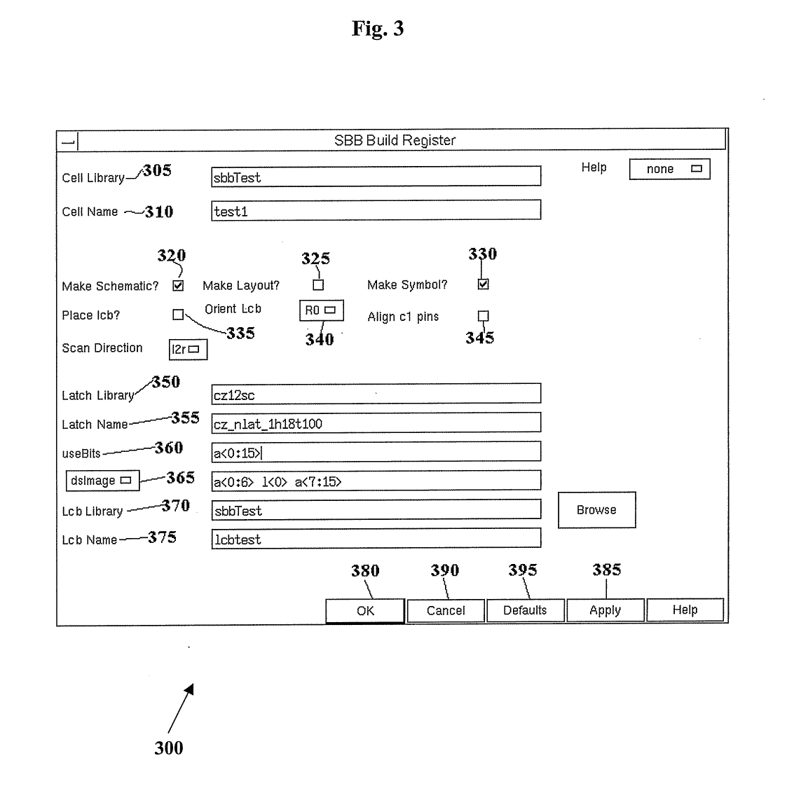

FIG. 3 depicts one embodiment of a GUI 300 utilized to obtain the parameters necessary for the designer 121 to execute the custom CADENCE™ functions described above to create the new cell. A cell library parameter 305 (dsParent) specifies a name and location of a library, that may include one or more previously created cells to use as a template, or foundation for creation of the new cell. A cell name parameter 310 defines a name of the new cell to be created. A make schematic check box 320, make layout check box 325 and make symbol check box 330 specify which cell entities will be created in response to the execution of the custom CADENCE functions. A place lcb check box 335 (placeLcb) determines if the local clock block will be included within the new cell, while an Orient LCB drop-down selector 340 (lcbRot) indicates a manner of orientation of the lcb, an Align c1 pins check box 345 (alignC1) indicates whether c1 pins of the cells will be aligned.

A Latch library parameter 350 (latLib) indicates a name of a library that includes one or more latches that have been previously created, and shall be use within the new cell, while a Latch name parameter 355 (latName) indicates a name of a latch within the indicated library that shall be utilized for creation of the new cell. A useBits (useBits) parameter 360 indicates which of the latches indicated by the Latch name parameter 355 shall be placed within the new cell, and a dsImage parameter 365 (dsImageArg) indicates an order in which the latches to be used shall be placed within the new cell.

A lcb library parameter 370 (lcbLib) indicates a library of previously created lcbs for use within the new cell, and a lcb name parameter 375 (lcbName) indicates which lcbs within the library shall be used to create the new cell.

In response to selection of the OK selector 380 or the Apply Selector 385, the designer 121 executes the one or more custom CADENCE functions using the obtained parameters described above, and thereby creates the new cell. A cancel selector 390 will close out the graphical user interface 300 and cease execution of the designer 121. A defaults selector shall select for the various parameters described above their factory or user defined default values.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While a preferred embodiment of the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media and comprising machine executable instructions for implementing a method of automatically creating a custom register circuit with a Computer Aided Design (CAD) application, the method comprising:
obtaining parameters of the custom register circuit via a graphical user interface;
executing one or more custom functions using the obtained parameters; and
creating a cell comprising the custom register circuit.

2. The computer program product of claim 1, wherein the obtaining parameters comprises:
obtaining at least one of a cell library parameter, a cell name parameter, a latch library parameter, a latch name parameter, a useBits parameter, a dsImage parameter, a lcb library parameter, a lcb name parameter, and a lcb dsType parameter via the graphical user interface.

3. The computer program product of claim 1, wherein the obtaining parameters comprises:
selecting at least one of a Make Schematic selection box, a Make Layout selection box, and a Make Symbol selection box displayed upon the graphical user interface.

4. The computer program product of claim 3, wherein the creating comprises:
creating the cell in response to the selection of at least one of the Make Schematic selection box, the Make Layout selection box, and the Make Symbol selection box.

5. The computer program product of claim 3, wherein the executing comprises executing one or more custom functions in response to the selection of at least one of the Make Schematic selection box, the Make Layout selection box, and the Make Symbol selection box.

6. A method for automatically creating a custom register circuit with an electronic Computer Aided Design (CAD) application, the method comprising:
obtaining parameters of the custom register circuit via a graphical user interface;
executing one or more custom functions using the obtained parameters; and
creating a cell comprising the custom register circuit.

7. The method of claim 6, wherein the obtaining parameters comprises:
obtaining at least one of a cell library parameter, a cell name parameter, a latch library parameter, a latch name parameter, a useBits parameter, a dsImage parameter, a lcb library parameter, a lcb name parameter, and a lcb dsType parameter via the graphical user interface.

8. The method of claim 6, wherein the obtaining parameters comprises:
selecting at least one of a Make Schematic selection box, a Make Layout selection box, and a Make Symbol selection box displayed upon the graphical user interface.

9. The method of claim 8, wherein the creating comprises:
creating the cell in response to the selection of at least one of the Make Schematic selection box, the Make Layout selection box, and the Make Symbol selection box.

10. The method of claim 8, wherein the executing comprises executing one or more custom functions in response to the selection of at least one of the Make Schematic selection box, the Make Layout selection box, and the Make Symbol selection box.
